(19) United States
(12) Patent Application Publication
(10) Pub. No.: US 2008/0106415 A1
(43) Pub. Date: May 8, 2008

(54) Information tag

(75) Inventors: Rosemary E. Sellew, Bend, OR (US); John C. Bohmker, Redmond, OR (US); Ricky L. Wright, Prineville, OR (US); Donald J. Rowden, Bend, OR (US)

Correspondence Address: KOLISCH HARTWELL, P.C., 520 SW YAMHILL STREET, Suite 200, PORTLAND, OR, 97204, US

(73) Assignee: MacSema, Inc.

(21) Appl. No.: 11/975,222

(22) Filed: Oct. 17, 2007

Related U.S. Application Data
(63) Continuation-in-part of application No. 11/595,686, filed on Nov. 8, 2006.

(51) Int. Cl. G08B 13/14

(52) U.S. Cl. 340/572.1

(57) ABSTRACT

An information tag for exchanging information with an external device, including a tag body, a contact memory module disposed on the tag body, the contact memory module being configured to exchange information with the external device via electrical conduction, and a first remotely accessible data module disposed on the tag body, the first remotely accessible data module being configured to exchange information with the external device without contact with the external device.

This application claims priority under 35 U.S.C. § 119(e) to U.S. Provisional Patent Application Ser. No. 60/735,010 filed on Nov. 8, 2005, and to U.S. patent application Ser. No. 11/595,686 filed on Nov. 8, 2006, the disclosures of which are incorporated herein by reference for all purposes.

### BACKGROUND

Information devices have long been used to associate information with a variety of objects. Conventional information devices include information stamped or printed on a relatively small size sheet of metal, plastic, or paper. Those information devices have been able to carry only a relatively small amount of information due to the small space available for printing the information. However, it may be desirable to provide more information than that which may be printed on the information device, or to periodically update the information that is available from the device.

For example, information relevant to maintenance applications may require considerable space and periodic updates. Information relevant to maintenance applications may include identification and configuration information for various types of machinery or equipment, such as motors, pumps, or aircraft components. Conventional information devices do not accommodate recording large amounts of information, and are not suited to modification once the information has been stamped or printed on the device. Additionally, printed or stamped information devices generally are accessible and reviewable by anybody, and thus are not suitable for use in maintaining confidentiality of information.

Information devices may contain information related to a particular object or item, and may be attached directly to such object or item for convenience of use. Because the information is stored electronically, these devices may be configured for use with an electronic reading device that reads the information stored on the device upon contact with the device. In recent years, with the decrease in size and cost of memory modules, information devices increasingly have been physically associated with the items for which information is contained. This has been accomplished, for example, by incorporating memory modules into fasteners (such as bolts, screws, or plugs), and securing such fasteners to the relevant item or object.

Exemplary fasteners with onboard information devices are described, for example, in U.S. Pat. No. 5,539,252 to Brorby, entitled FASTENER WITH ONBOARD MEMORY. Fasteners with onboard memory modules also are described in US Patent Publication No. US 2004/0135668 to Hoffer et al., entitled CLOSURE SYSTEM AND METHOD. U.S. Pat. No. 5,539,252 and US Patent Publication No. US 2004/0135668 are incorporated herein by this reference thereto.

Additional examples of information devices are described in the following references, which are each incorporated herein by reference for all purposes: U.S. Pat. Nos. 5,939,984, 6,046,676, 6,147,604, 6,356,197, 7,009,517, and 7,106,198; US Published Applications 20060009856, 20060208853, 20060097847, 20060113371, 20060133609, 20060145876, and 20060208089.

Although the aforementioned devices have proven suitable for use in associating information with items, they generally have not been adapted to provide for remote access of data.

### BRIEF DESCRIPTION OF THE DRAWINGS

FIG. 1 is a perspective view showing an information tag according to the present disclosure, the tag employing both a contact memory module and a remotely accessible data module.

FIG. 2 is a side view of a cross section of the information device shown in FIG. 1, the tag being mounted on an item for which information is stored.

FIG. 3 is a schematic view showing exemplary circuitry for use in the contact memory module of FIG. 1.

FIG. 4 is a top view of an information tag according to the present disclosure, the tag employing a contact memory module with an extended flange tab on which a remotely accessible data module is mounted.

FIG. 5 is a top view of an information tag according to the present disclosure, the tag employing a contact memory module with an integral remotely accessible data module.

FIG. 6 is a top view of an information tag employing a contact memory module and remotely accessible data module according to the present disclosure, the contact memory module including circumferential contact pads that surround the remotely accessible data module.

FIG. 7 is a top view of an information tag employing a contact memory module and remotely accessible data module according to the present disclosure, the contact memory module including contact pads arranged around a perimeter of the remotely accessible data module.

FIG. 8 is a top view of an information tag similar to that shown in FIG. 7, but with the contact memory module including contact pads arranged around the perimeter of the remotely accessible data module in a different configuration.

FIG. 9 is a perspective view of an external device interacting with an information tag similar to that shown in FIG. 1.

FIG. 10 is a perspective view of an external device approaching contact with the information tag similar to that shown in FIG. 1, portions of the external device and information tag being enlarged for clarity.

FIG. 11 is an exploded perspective view of an information tag with a contact memory module and remotely accessible data modules, the contact memory module being applied through an aperture in a tag body suited for attachment to an item.

FIG. 12 is a perspective view of an information tag with a contact memory module and remotely accessible memory modules, the contact memory module and remotely accessible data modules being applied to a surface of a curved tag body for combined attachment to an item.

FIG. 13 is a perspective view of an information tag with a contact memory module and remotely accessible memory modules mounted together on a tag body to form a unitary information tag with both contact-accessible information and remote-accessible information.

### DETAILED DESCRIPTION

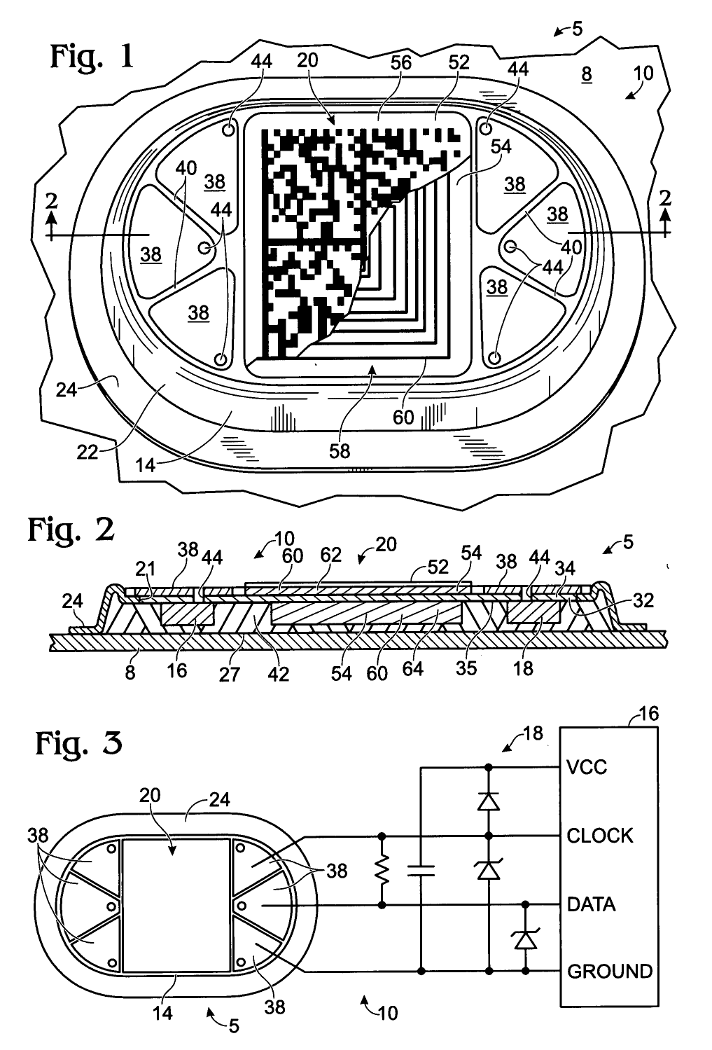

Referring initially to FIGS. 1-3, an information tag 5 is shown, the depicted information tag being suited for storing and retrieving information in association with an object or item 8 to which the tag may be secured. As indicated, information tag 5 may include a contact memory module 10 and one or more remotely accessible data modules (indicated generally at 20). Contact memory module 10, in turn, may include a casing 14, memory 16 and a control circuit 18. As best illustrated in FIGS. 1 and 2, the contact memory module 10 and remotely accessible data modules may be integrated, the remotely accessible data modules being mounted on the contact memory module to provide a somewhat compact information device.

In the embodiment of FIGS. 1-3, casing 14 provides housing for components of the information tag, the casing taking the form generally of a single-piece tubular metal housing that defines a channel 21 between opposite casing ends. In some examples, casing 14 may take the form of an eyelet, such as a Stimpson A37 eyelet. Such an eyelet, it will be appreciated, may include a barrel 22 (defining channel 21) with a lower perimeter flange 24.

Information tag 5 may include an attachment region 27 for securing the information tag to item 8. The attachment region may be defined at one end of barrel 22, typically distal from contact surfaces 38 (described below), so as to accommodate reading of the information tag using contact surfaces 38. In some examples, the attachment region is located on an underside of the information tag to receive an adhesive used in securing the information tag to an item for which information is stored. It will be appreciated, however, that the attachment region also may accommodate attachment of the information tag to the item via a resilient snap ring, or other fastener device.

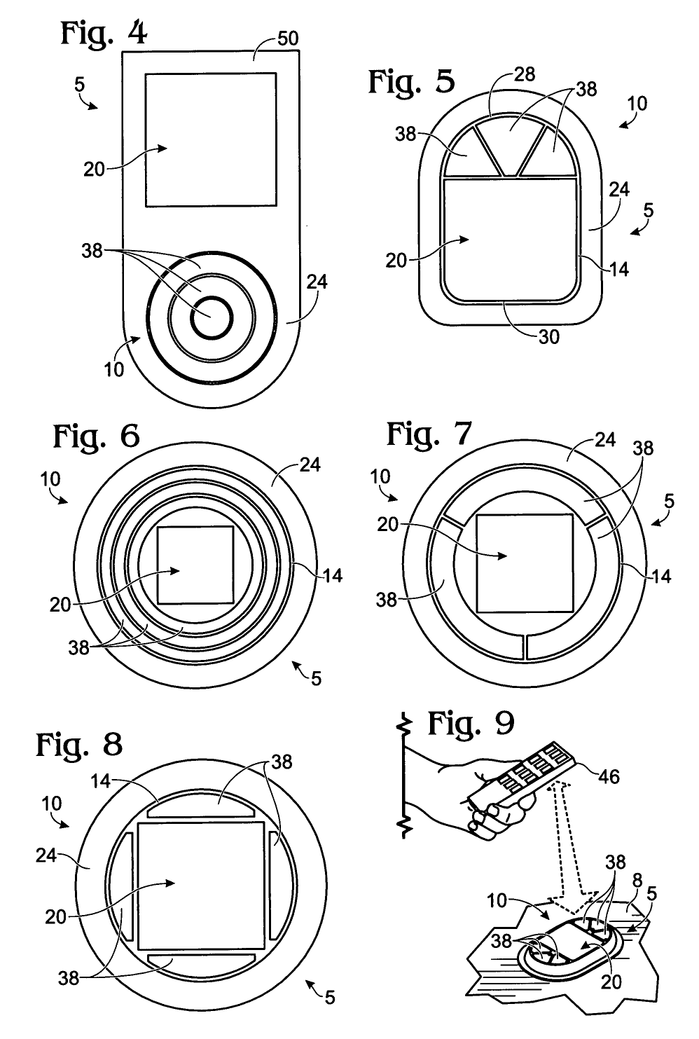

Casing 14 may take any shape convenient for attachment of the information tag to an item (e.g., machinery, avionics, containers, weapons, or equipment). Exemplary casing configurations are shown in FIGS. 1 and 4-8. As indicated, casing 14 may be generally circular, oblong, oval, square, or rectilinear (among other configurations). FIG. 1, for example, shows an oval casing. FIG. 4 shows a casing having a protruding flange that carries a remotely accessible data module (indicated generally at 20). FIG. 5 shows a casing that defines a barrel with a curved portion 28 and a straight portion 30 (opposite curved portion 28). This configuration may provide a smaller footprint than some of the other depicted configurations.

Casing 14 may support and/or contain any number of electronic or other devices, including (but not limited to) memory 16. Memory 16 may take the form of nonvolatile memory, or volatile memory, for use in connection with a microprocessor. As should be apparent, memory 16 may utilize any of a variety of memory technologies, including semiconductor memory, magnetic storage media, optical storage media, etc. Other devices that may be supported/contained in casing 14 include clocks, sensors (such as temperature, vibration, or other sensors), or tracking devices; etc.

As used herein, “store” and “stored” means that information or data is at least temporarily placed in memory for retrieval later. Stored information may be temporarily stored or permanently stored. Temporarily stored information may be subsequently erased or overwritten with other information, while permanently stored information typically is not subsequently erased or overwritten with other information. Information may be stored in any suitable format, with or without compression and/or encryption.

Contact memory module 10 may include a control circuit 18 electrically coupled to memory 16 (as depicted schematically in FIG. 3). Control circuit 18 may be formed on a rigid, generally planar, printed circuit board 32 formed to fit somewhat closely within barrel 22. As indicated, printed circuit board 32 may include one or more electrically conductive contact surfaces 38 on a first side 34 of the circuit board. First side 34, in turn, may include through-holes 44, which provide electrical connectivity to the control circuit and memory (mounted on a second side 35 of printed circuit board 32), and thus provide access to information stored in memory 16 (via control circuit 18).

The contact surfaces may be substantially planar, accommodating physical contact by an external reading device. For example, the information tag depicted in FIGS. 1-3 has six contact surfaces separated into two groups of three. In some embodiments, the contact surfaces may be electrically isolated from each other, and from casing 14, to provide distinct electrical connections to the control circuit and memory. In other embodiments, corresponding contact surfaces of the two groups may be electrically connected to allow application of an external reader in either of two opposite orientations.

The information tag depicted in FIG. 4 includes three contact surfaces, forming concentric circles so as to accommodate application of an external reader in various orientations. Other arrangements of contact surfaces (such as that shown in FIG. 5) may require a keyed relationship between the information tag (e.g., via the barrel of the casing) and the external reader in order to ensure proper reading of the information on the information tag. It will be appreciated that other configurations are also possible, non-limiting examples of which are shown in FIGS. 6-8.

As noted, contact surfaces may be electrically isolated from each other, and from the casing, to provide distinct electrical contacts. Accordingly, contact memory module 10 (shown, for example, in FIGS. 1-3) may be seen to include nonconductive insulation boundaries 40 that facilitate electrical isolation of contact surfaces 38. One or more of insulating boundaries 40 may be defined by printed circuit board etching, and electrically connected to the control circuitry and memory using through-holes 44. The contact surfaces and through-holes 44 thus may be arranged in a pattern to facilitate rapid connection between an external device 46 and a contact memory module including memory 16.

In some embodiments, a non-conductive potting material 42 may be provided to maintain printed circuit board 32 within casing 14. The potting material 42 thus may protect (for example, hermetically seal) memory 16 from environmental conditions, such as moisture. Toward this end, the potting material may be added to channel 21 of barrel 22, while the potting material is in a partially liquid or pourable state, after the printed circuit board has been placed into the casing. Potting material added in this manner may fill voids between components coupled to printed circuit board 32. The potting material may subsequently harden. In some examples, a remotely accessible data module also may be disposed within the potting material 42 when it is in a partially liquid or pourable state.

An information tag may include one or more remotely accessible data modules, each adapted to accommodate wireless transfer of data contained thereon from the information tag to an external device. Wireless transfer of data between an exemplary information tag 5 and an exemplary external device 46 is shown in FIG. 9.

Referring now to FIGS. 4-8, it will be appreciated that a remotely accessible data module 20 may be mounted in any of a variety of locations on information tag 5. FIG. 4, for example, depicts placement of remotely accessible data module 20 on extended flange tab 50 of casing 14. FIGS. 5-8 depict placement of remotely accessible data module 20 in various positions on a circuit board underlying contact surfaces 38. Other arrangements are possible, as will be understood upon reading further.

In some examples, such as that shown in FIG. 1, information tag 5 may include both a first remotely accessible data module 52 and a second remotely accessible data module 54. These remotely accessible data modules may be similar, or more commonly, may take different forms to accommodate reading of data using different external devices and/or different reading methodologies.

First remotely accessible data module 52 may include a symbology element 56 that is optically readable by an external device. Symbology element 56 may take the form of a machine readable barcode, such as the 2D Datamatrix barcode shown in FIG. 1. An external device (such as that shown in FIG. 9) may be used to wirelessly read symbology element 56 by emitting light toward symbology element 56, and then processing the returning light reflected from the symbology element.

Symbology elements may be secured in place in any of a number of different ways. For example, symbology element 56 may be formed onto an adhesive label, which may then be applied to a desired surface of the information tag. Additionally or alternatively, symbology element 56 may be etched onto a metal insert, such as with laser etching, and the metal insert may be secured to a desired portion of the information tag. In some examples, symbology element 56 is directly etched onto a surface of the information tag, such as a surface of the casing or the printed circuit board.

Laser etching is one possible method of directly marking a symbology element onto an information tag. Additionally or alternatively, the symbology element may be marked by chemical etching, chemical marking, mechanical engraving, dot peening, printing, etc. Symbology element 56 may be applied by a manufacturer of the information tag, or may be applied by any user of the information tag after manufacture and/or purchase. The latter may provide certain functionality and flexibility for any such user. Other marking methods similarly may be employed.

Second remotely accessible data module 54 may include a transceiver 58 for use in communicating data wirelessly using an electromagnetic signal. In some examples, remotely accessible data module 54 may be configured to both transmit and receive data. In other examples data may be read wirelessly, but not rewritten. The electromagnetic signals used to communicate data may include radio frequency waves, infrared light, and/or magnetic fields. Thus, additionally or alternatively to a transceiver, second remotely accessible data module 54 may be described as including a radio frequency identification device, an infrared identification device, and/or a magnetic identification device. As will be appreciated, transceiver 58 may be electrically connected to memory 16 to facilitate data exchange between external device 46 and memory 16.

Transceiver 58 may take the form of a radio frequency identification device (“RFID”) 60. RFID 60 may include an antenna 62 to transmit and/or receive a signal and a processing circuit 64 to generate and/or process the signal. In some examples, the processing circuit may form a part of the control circuit of the contact memory module. RFID 60 may optionally include internal memory for storing data.

RFID 60 may be active, passive, or a combination of operating modes known as semi-active. An active RFID typically includes an internal power source to power signal generation by the integrated circuit. A passive RFID typically does not include an internal power supply, but instead is powered by the electrical current induced in antenna 62 by a carrier signal sent by external device 46. Integrated circuit 64 in a passive RFID may backscatter the carrier signal to transmit information using less power than an active RFID. Backscattering the carrier signal may extend the distance in which information exchange is possible.

Remotely accessible data modules 52, 54 may couple with or be applied to circuit board 32 (or other components) of contact memory module 10 in a variety of ways, including in layers. As illustrated in FIGS. 1 and 2, second remotely accessible data module 54 may be disposed in layered fashion between first remotely accessible data module 52 and circuit board 32. Alternative arrangements also are possible. For instance, a first remotely accessible data module may couple with or be applied to a first side 34 of circuit board 32 and a second remotely accessible data module may be positioned inside casing 14. Furthermore, both the first and second remotely accessible data modules may be positioned on the first side of circuit board 32. For example, a second remotely accessible data module may be coupled with or applied to first side 34 of surface board 32 adjacent first remotely accessible data module (also coupled with or applied to first side 34 of circuit board 32).

In some examples, such as shown in FIG. 2, second remotely accessible data module 54 is a RFID 60 with components on both first side 34 and second side 35 of circuit board 32. Antenna 62 of RFID 60 may be positioned on first side 34 of circuit board 32. In some examples, antenna 62 may be integrally formed in circuit board 32. Processing circuit 64 of RFID 60 may be positioned on second side 35 of circuit board 32. In yet another example, RFID 60 includes components positioned within potting material 42.

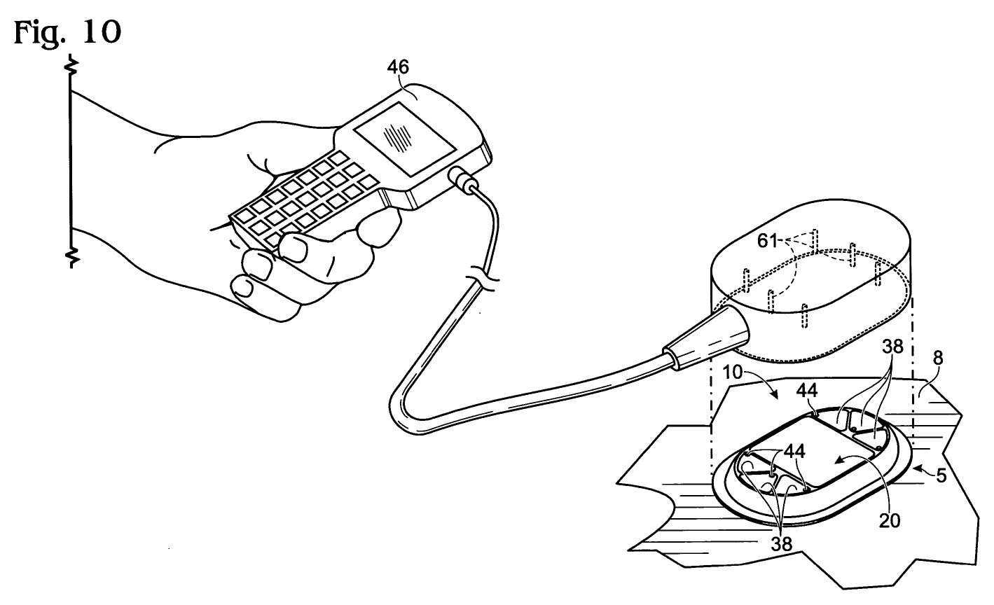

External device 46 may be configured to interface with information tag 5 in multiple ways. For example, external device 46 may exchange information by contacting contact surfaces 38 (shown in FIG. 10), by optically reading information from symbology element 56 of first remotely accessible data module 52, and/or by sending or receiving electromagnetic signals to/from RFID 60 of second remotely accessible data module 54 (shown in FIG. 9).

As best shown in FIG. 10, external device 46 may include a contact reader with pins 61 configured to contact the contact surfaces 38 of contact memory module 10 of information tag 5 so that external device 46 can read data from and/or write data to memory 16. Contact between external device 46 and contact surfaces 38 in the desired orientation thus may allow external device 46 to exchange information with memory 16.

In addition to reading information from the contact memory module by contacting contact surfaces 38, external device 46 may read data from and/or write data to information tag 5 remotely using a variety of wireless data transfer methods. For example, external device 46 may read identification information optically from symbology element 56 of information tag 5. Further, external device 46 may transmit and/or receive identification information via transceiver 58 of information tag 5. Identification information may include information suitable for use in identifying characteristics of a contact memory module and/or identification tag, in contrast to information (e.g., maintenance information) about an item to which the identification tag is secured, which typically is stored in memory of the contact memory module.

In some examples, external device 46 may include a microprocessor configured to process data read from information tag 5 and/or write data to the contact memory module of information tag 5. External device 46 also may include a user interface for operating external device 46, and/or for programming the contact memory module of the information tag. Alternatively, or additionally, external device 46 may be a peripheral device of another device configured to process data received data from the information tag and/or write data to the contact memory module of the information tag.

In operation, a user may secure the information tag to item 8, store information (e.g., maintenance information) about item 8 in memory of information tag 5, and subsequently retrieve the stored information using external device 46. Information can be modified, erased, rewritten, or supplemented, as desired, using external device 46. In this manner, ongoing activities (e.g., maintenance) associated with item 8 may be tracked When access to information related to item 8 is no longer needed, information tag 5 can be removed, erased, and selectively re-attached to a different item.

Information tag 5 may be secured to item 8 in any of a variety of ways. For example, information tag 5 may be secured to item 8 with adhesives. Alternatively, or additionally, information tag 5 may be bolted or otherwise secured to item 8 using any of a number of fastening devices. Attaching information tag 5 to item 8 may be selective and reversible, i.e. in some examples information tag 5 may be secured and removed from item 8 multiple times.

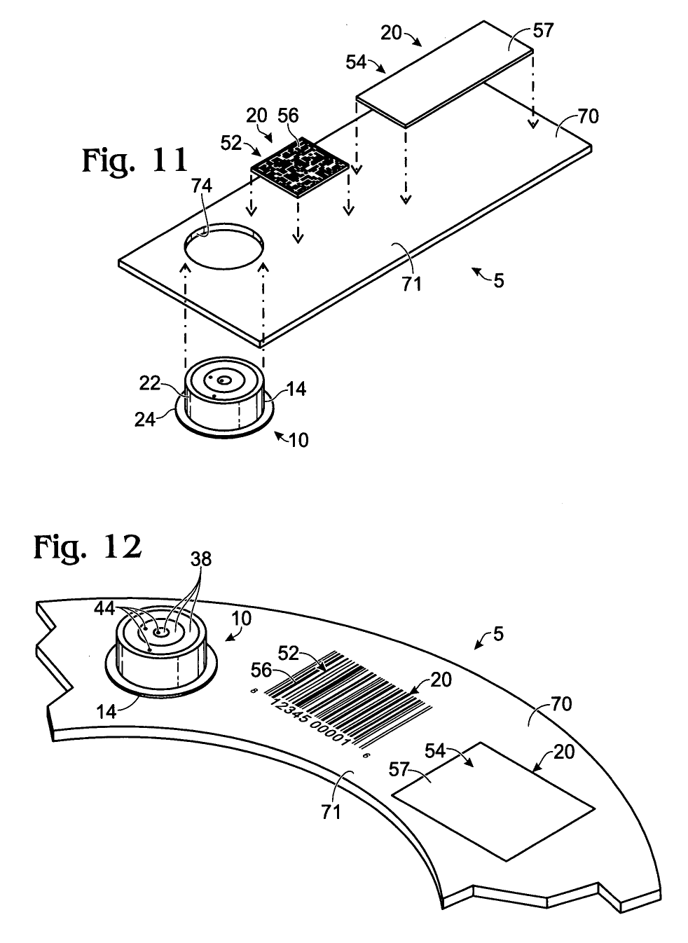

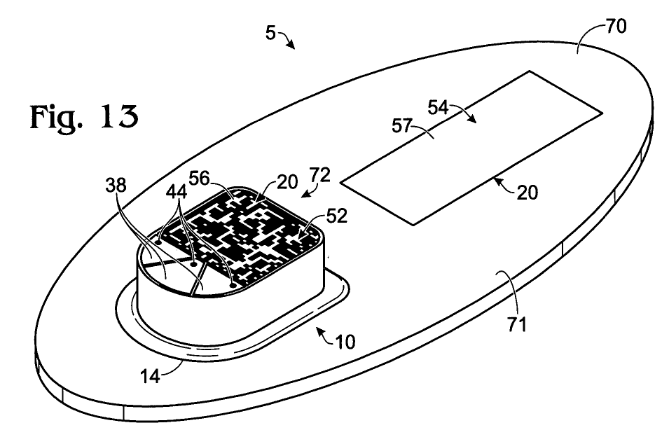

Referring now to FIGS. 11-13, yet another exemplary information tag 5 is shown during assembly thereof. As indicated, the depicted information tag may include a tag body 70 configured for receipt of a contact memory module 10 and one or more distinct remotely accessible data modules 20. As indicated in the various exemplary illustrations, the tag body may take any of a variety of different configurations, including rectangular (FIG. 11), arcuate (FIG. 12), and oval (FIG. 13). Other configurations are possible.

Tag body 70 may be formed of any of a variety of materials, including metals or polymers, to provide a surface 71 on which text, indicia, and other symbols may be displayed. Tag body 70 may be attached by any suitable means to a variety of items, including pipes, vessels, processing equipment, electronic equipment, tools, cargo, vehicles, building structures, and the like, as described generally above with respect to FIGS. 1-3.

In the information tag of FIG. 11, tag body 70 defines an aperture 74 through which contact memory module 10 may be inserted. Once inserted, the contact memory module may be secured to the tag body, for example, using an adhesive or the like. In some examples (FIGS. 12 and 13), the contact memory module is surface mounted on the tag body. In these examples, the contact memory module again may be secured to the tag body using an adhesive or the like. It will be appreciated, however, that the contact memory module may be secured to the tag body via other attachment mechanisms, including fasteners.

Still referring to FIG. 11, it will be noted that a first remotely accessible data module 52 may be placed on a first side 71 of tag body 70. As indicated, first data module 52 may take the form of a symbology element 56 disposed on a substrate configured for surface-mounting on tag body 70. In one example, the symbology element may be printed on a strip of adhesive tape. In another example (FIG. 12), the symbology element may be printed directly on the tag body. In yet another example (FIG. 13), the symbology element may be placed on the contact memory module as described above with respect to FIGS. 1-3.

Symbology element 56 may be a machine readable barcode, such as a 2D Datamatrix barcode as shown in FIGS. 11 and 13, a vertical line sequence barcode as shown in FIG. 12, or some other form of electronically readable image. Symbology element 56 may be produced by printing (as indicated above), engraving, dot peeing, or any other suitable methodology.

Information tag 5 also may include a second remotely accessible data module 54, also disposed on tag body 70, as shown in FIGS. 11-13. It will be appreciated that second remotely accessible data module 54 may take the form of an RFID, as described in detail above. In some examples (FIG. 11), second remotely accessible data module 54 is disposed on a substrate configured for surface-mounting on tag body 70, whether on a top surface 71 of tag body or on a bottom surface 73 (FIG. 11). In other examples (FIGS. 12 and 13), the second remotely accessible data module 54 is formed directly on the tag body.

In yet other examples, the second remotely accessible data module 54 is formed integral with the contact memory module, as described generally above with reference to FIGS. 1-10. The second remotely accessible data module may also be disposed within the tag body, such as being encased or embedded within the tag body or sandwiched between layers of the tag body. In some examples, the tag body includes a window or aperture in which the second remotely accessible data module is disposed.

Information tag 5 may also include an insulating layer 75 disposed between tag body 70 and an item to which the information tag is secured. As shown in FIG. 11, second remotely accessible data module 54 may be disposed between tag body 70 and insulating layer 75. In some examples, insulating layer 75 provides a standoff for the second remotely accessible data module 54. The standoff has particular applicability when item 8 is metallic, but insulating layer 75 may also be employed to provide a standoff when item 8 is not metallic. Indeed, in examples where second remotely accessible data module 54 includes a transmitter or receiver, the standoff provided by insulating layer 75 can facilitate radio frequency transmission or reception by the transmitter or receiver, respectively.

While embodiments of an information device and methods of use thereof have been particularly shown and described, many variations may be made therein. This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed.

Where the disclosure recites “a” or “a first” element or the equivalent thereof, such recitations include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

Inventions embodied in various combinations and subcombinations of features, functions, elements, and/or properties may be claimed through presentation of claims in a related application. Such claims, whether they are directed to different inventions or directed to the same invention, whether different, broader, narrower or equal in scope to the other claims, are also regarded as included within the subject matter of the present disclosure.

What is claimed is:

1. An information tag for exchanging information with an external device, comprising:
a tag body;
a contact memory module supported by the tag body, the contact memory module being configured to exchange information with the external device via electrical conduction; and
a first remotely accessible data module supported by the tag body, the first remotely accessible data module being configured to exchange information with the external device without contact with the external device.

2. The information tag of claim 1, wherein the first remotely accessible data module includes a symbology element.

3. The information tag of claim 1, wherein the first remotely accessible data module includes a radio frequency identification device.

4. The information tag of claim 1, wherein the first remotely accessible data device includes an infrared identification device.

5. The information tag of claim 1, wherein the first remotely accessible data module is printed onto the tag body.

6. The information tag of claim 1, further comprising a second remotely accessible data module supported by the tag body.

7. The information tag of claim 6, wherein the first remotely accessible data module includes a radio frequency identification device and the second remotely accessible data module includes a symbology element.

8. The information tag of claim 1, wherein the tag body defines an aperture and the contact memory module is supported within the aperture.

9. An information tag for exchanging information with an external device, comprising:
a tag body;
a contact memory module including a casing mounted on the tag body, onboard memory configured to store information, one or more contact surface in operative connection with the memory to provide for exchange of information with the external device via electrical conduction when in contact with the external device; and
a first remotely accessible data module supported by the tag body and configured to exchange information with the external device without contact with the external device.

10. The information tag of claim 9, wherein the first remotely accessible data module includes a radio frequency identification device.

11. The information tag of claim 9, wherein the first remotely accessible data module includes an infrared identification device.

12. The information tag of claim 9, wherein the first remotely accessible data module includes a symbology element displaying information.

13. The information tag of claim 9, further comprising a second remotely accessible data module.

14. The information tag of claim 13, wherein the first remotely accessible data module includes a radio frequency identification device and the second remotely accessible data module includes a symbology element.

15. The information tag of claim 14, wherein the second remotely accessible data module is supported by the first remotely accessible data module.

16. The information tag of claim 9, wherein the first remotely accessible data module is printed onto the tag body.

17. The information tag of claim 9, wherein the tag body includes an aperture and the housing is supported by the tag body within the aperture.
